(19) United States
(12) Patent Application Publication
(10) Pub. No.: US 2004/0225832 A1
(43) Pub. Date: Nov. 11, 2004

(54) Portable USB storage device having a storage medium formed of a DRAM

(75) Inventor: Wen Yen Huang, Hsinchu City (TW)

Correspondence Address: BACON & THOMAS, PLLC, 625 SLATERS LANE, FOURTH FLOOR, ALEXANDRIA, VA, 22314

(73) Assignee: Sunplus Technology Co., Ltd., Hsin-Chu (TW)

(21) Appl. No.: 10/679,458

(22) Filed: Oct. 7, 2003

(30) Foreign Application Priority Data
May 7, 2003 (TW) 92208360

(51) Int. Cl. G06F 12/00

(52) U.S. Cl. 711/105

(57) ABSTRACT

A portable USB storage device is provided. The USB storage device has a USB connector having power and data pins. A USB controller is connected to the data pins and a DRAM unit for controlling data access of the DRAM unit. A refreshing circuit is coupled to the power pins. The refreshing circuit is operative to refresh the DRAM unit when the USB connector is inserted into a socket of a host. A rechargeable battery is charged via the power pins when the USB connector is inserted into the socket of the host. The rechargeable battery is operative to supply power to the DRAM unit and the USB controller. In response to disconnecting the USB connector from the host, the DRAM unit is switched to a self-refreshing mode by the USB controller and the USB controller enters into a power saving mode.

### BACKGROUND OF THE INVENTION

1. Field of the Invention

The present invention relates to portable USB (Universal Serial Bus) storage devices and, more particularly, to such a portable USB storage device having a storage medium formed of a DRAM (dynamic random access memory).

2. Description of Related Art

Conventionally, a storage medium of a portable USB storage device is formed of a flash memory. Even though a typical USB storage device has a size of about a human thumb, the data capacity of the USB storage device is from about several tens up to about several hundreds megabytes (MB). Also, a rapid data transfer speed of, for example, USB2.0 is about 470 MB/s due to the improvements in USBs. However, the data transfer speed of a flash memory is relatively low as compared with that of USB2.0, resulting in a bottleneck of data transfer speed increase. Moreover, the high cost of a flash memory has prevented the conventional USB storage from becoming widely used.

Therefore, it is desirable to provide a novel portable USB storage device in order to mitigate and/or obviate the aforementioned problems.

### SUMMARY OF THE INVENTION

The object of the present invention is to provide a portable USB storage device having a storage medium formed of a DRAM. The present invention has the advantages of being convenient in use, fast operation, and low cost.

To achieve the above and other objects, the portable USB storage device in accordance with the present invention includes: a USB connector having power pins and data pins; a DRAM unit; a USB controller connected to the data pins and the DRAM unit for controlling data access of the DRAM unit; a refreshing circuit coupled to the power pins, the refreshing circuit being operative to supply refreshing pulses to the DRAM unit when the USB connector is inserted into a socket of a host; and a rechargeable battery charged via the power pins when the USB connector is inserted into the socket of the host, the rechargeable battery being operative to supply power to the DRAM unit and the USB controller, wherein, responsive to disconnecting the USB connector from the host, the DRAM unit is switched to a self-refreshing mode by the USB controller and the USB controller enters into a power saving mode.

Other objects, advantages, and novel features of the invention will become more apparent from the detailed description when taken in conjunction with the accompanying drawing.

### BRIEF DESCRIPTION OF THE DRAWING

FIG. 1 is a block diagram of a preferred embodiment of portable USB storage device according to the invention.

### DETAILED DESCRIPTION OF THE PREFERRED EMBODIMENT

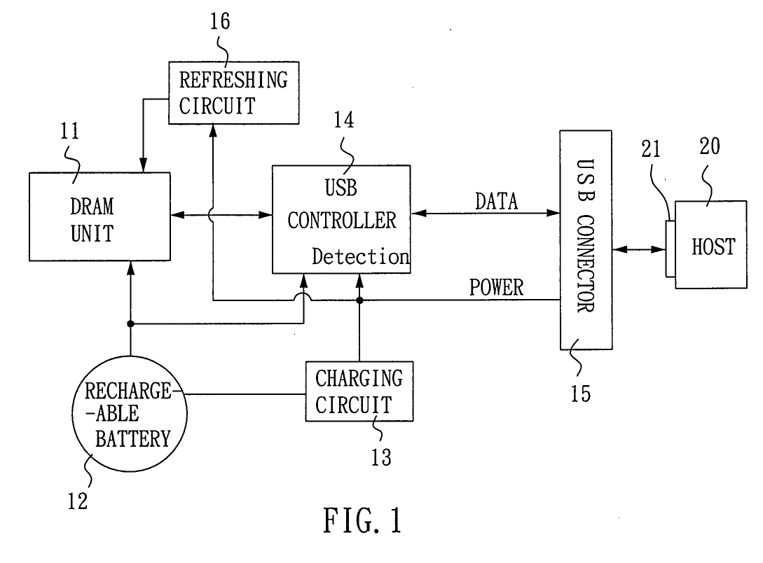

With reference to FIG. 1, there is shown a portable USB storage device constructed in accordance with the invention, which includes a DRAM unit 11, a rechargeable battery 12, a charging circuit 13, a USB controller 14, a USB connector 15, and a refreshing circuit 16. The USB connector 15 is inserted into a USB socket 21 of a host (e.g., computer) 20. As such, the host 20 is able to access data from the USB storage device via the USB socket 21 and the USB connector 15. The USB interface defines power pins (+5 V and GND) and data pins (D+ and D−).

The host 20 will issue an instruction to the charging circuit 13 via the power pins for causing the charging circuit 13 to charge the rechargeable battery 12 when the USB connector 15 is inserted into the USB socket 21. Power required for operating the DRAM unit 11 and the USB controller 14 is supplied by the rechargeable battery 12. Also, the power pins of the USB connector 15 are coupled to the refreshing circuit 16 for commanding the refreshing circuit 16 to supply refreshing pulses to the DRAM unit 11. The USB controller 14 is connected the data pins of the USB connector 15 and the DRAM unit 11 so as to control data access of the DRAM unit 11 by the host 20 via the USB connector 15.

A detection pin of the USB controller 14 coupled to the power pins of the USB connector 15 is able to detect a disconnection of the USB storage device from the host 20, whereby a power supply to the refreshing circuit 16 from the USB connector 15 is interrupted in response to the disconnection. Next, the DRAM unit 11 is switched to a self-refreshing mode by the USB controller 14. Thereafter, the USB controller 14 automatically enters into a power saving mode (e.g., sleep mode or power-down mode) in which a small power is fed to the DRAM unit 11 for maintaining data integrity thereof by the rechargeable battery 12.

In view of the foregoing, it is known that the present invention is characterized in using a DRAM as the storage medium of the portable USB storage device, and changing the DRAM refreshing mode by detecting the insertion/removal status of the portable USB device. In comparison with the fresh memory, DRAM has a faster data access speed. Hence, a bandwidth of USB2.0 can be fully utilized by the DRAM. For example, about 30 seconds is required to transfer 32 MB data from a personal computer (PC) to a flash memory for being stored via a USB2.0. As a comparison, only about 1.5 seconds is required to transfer the same data from the PC to the DRAM for being stored via a USB2.0. In other words, a time saving of about 20 times is obtained by the invention. Moreover, cost of the DRAM per unit is from about one third to about one half as compared with that of a flash memory. In addition, data deletion in a portable USB storage device having a storage medium formed of conventional flash memory is done by a PC or by applying voltage to the storage medium. In comparison, data deletion in a portable USB storage device having a storage medium formed of a DRAM according to the invention is done by simply temporarily removing the rechargeable battery 12 from supplying power to the DRAM unit 11. In view of the above, the USB storage device of the invention can carry out convenient, fast, and cost effective data storage.

Although the present invention has been explained in relation to its preferred embodiment, it is to be understood that many other possible modifications and variations can be made without departing from the spirit and scope of the invention as hereinafter claimed.

What is claimed is:

1. A portable USB storage device, comprising:
a USB connector having power pins and data pins;
a DRAM unit;
a USB controller connected to the data pins and the DRAM unit for controlling data access of the DRAM unit;
a refreshing circuit coupled to the power pins, the refreshing circuit being operative to supply refreshing pulses to the DRAM unit when the USB connector is inserted into a socket of a host; and
a rechargeable battery charged via the power pins when the USB connector is inserted into the socket of the host, the rechargeable battery being operative to supply power to the DRAM unit and the USB controller, wherein, responsive to disconnecting the USB connector from the host, the DRAM unit is switched to a self-refreshing mode by the USB controller and the USB controller enters into a power saving mode.

2. The portable USB storage device as claimed in claim 1, further comprising a charging circuit coupled to the power pins, the charging circuit being operative to charge the rechargeable battery in response to receiving an instruction from the power pins.

3. The portable USB storage device as claimed in claim 1, wherein the USB controller comprises a detection pin coupled to the power pins, the detection pin being adapted to detect the disconnection of the USB storage device from the host.

4. The portable USB storage device as claimed in claim 1, wherein the power pins are comprised of a +5 V pin and a ground pin and the data pins are comprised of a D+ pin and a D− pin.
